(19) United States
(12) Patent Application Publication
(10) Pub. No.: US 2011/0200724 A1
(43) Pub. Date: Aug. 18, 2011

(54) Preparation Method of Cooked Rice in Aseptic Packing System Using Embryo Bud-Containing Rice

(75) Inventors: Hyo-Young Jeong, Seoul (KR); Chang Yong Lee, Seoul (KR); Tae Hyeong Kim, Gyeonggi-do (KR); Jun Bong Choi, Seoul (KR); Hye-Won Shin, Seoul (KR); Min-Soo Kim, Gyeonggi-do (KR)

(73) Assignee: CJ Cheiljedang Corporation, Seoul (KR)

(21) Appl. No.: 12/745,338

(22) PCT Filed: Nov. 27, 2008
(86) PCT No.: PCT/KR08/06987

§ 371 Date: Oct. 20, 2010

(30) Foreign Application Priority Data
Nov. 30, 2007 (KR) 10-2007-0123724

(51) Int. Cl. A23L 1/182

(52) U.S. Cl. 426/392

(57) ABSTRACT

A method is provided for preparing an instant embryo bud-retaining white rice product. The rice is polished like white rice using a low-speed, uniform pressure method to keep embryo buds and is rich in nutrients and has white rice's flavor. Its lipid oxidation is similar to that of white rice. The immersion time period of the embryo bud-retaining white rice is controlled so as not to generate sticky materials after the immersion, thus allowing effective sterilization of the rice. Therefore, the instant embryo bud-retaining white rice can be stored at room temperature for 6 months or longer.

### TECHNICAL FIELD

The present invention relates to a method for preparing an instant, embryo bud-retaining white rice product.

### BACKGROUND ART

In general, a kernel of unpolished brown rice consists of a rice bran layer, including the pericarp, testa and an aleuron layer, and an embryo constituting a small portion of the basal part of the rice grain, with the balance being endosperm. As such, the endosperm is composed mainly of starch and thus corresponds to the part which is edible as fully-milled white rice. Because its nutrients are not loosened by milling, brown rice is richer in lipids, proteins, γ-oryzanol and vitamins A, B1 and B2 and thus is nutritionally far superior to white rice. However, brown rice is not popularized due to its shortcomings: it tastes poor, has a coarse texture and is difficult to cook and its nutrients are not digested/absorbed sufficiently. Thus, most of the commercially available rice is white rice, which is devoid of bran and embryo buds.

According to studies, the embryo buds of rice, which are removed when milling white rice, contain as much as 66% of the total rice nutrients and have phytic acid, known to remove heavy metals, in an amount six times larger than does white rice. Also, the embryo buds of rice are reported to be rich in proteins, lipids and carbohydrates. Balanced amounts of fibroid materials, vitamins and minerals, such as vitamin A, vitamin B1, B2 and B6, vitamin E, pantothenic acid, linoleic acid and the like, are contained in the embryo buds of rice. Further, chelators inhibitory of carcinogens are detected in the embryo buds of rice. In addition, tocotrienol, which is of more potent antioxidant activity than tocopherol, as well as oryzanol, which is preventative of cerebral apoplexy and dementia because it activates brain cells, are found in the embryo buds of rice. Their abundant fibroid content is known to increase water content in rice, thus preventing constipation. Recent studies have shown that the embryo buds reduce the insulin response of the meal and thus are effective in the prevention of diabetes.

With the increasing attention to health, extensive studies have been conducted into a rice which overcomes the disadvantages of brown rice including coarse taste and being difficult to digest, yet has the retention of brown rice's nutrients. For example, germinated brown rice which people do not feel uncomfortable to eat and is rich in nutrients, partially polished rice with embryo buds which is polished by a special mill to retain embryo buds, and embryo bud-retaining white rice which overcomes the disadvantages of the partially polished rice have been developed.

Rich in proteins, minerals, amino acids, calcium, various vitamin B groups, and dietary fibers, germinated brown rice is known to be preventive of arteriosclerosis, hypertension, diabetes and heart diseases as well as being effective in the prevention and treatment of cancer. In addition, germinated brown rice can be cooked like white rice and is convenient to eat without feeling coarse to chew.

The content of the aleuron layer (bran) is 3˜4% larger in partially polished rice with embryo buds than in white rice, so that partially polished rice with embryo buds gives off a coarse feeling like brown rice when eaten, and when cooked, it turns brown, decreasing the appetite. Partially polished rice with a whiteness of from 32 to 34 contains a significant amount of bran which is rich in lipid, with an embryo bud retention rate of 80% or higher, so that it is likely to undergo acidification and denaturation during storage.

Embryo bud-retaining white rice comes from the polishing of rice seeds at a level similar to white rice, but with the retention of embryo buds. Thus, embryo bud-retaining white rice is richer in nutrients than and has almost the same taste sensation as white rice. It has a whiteness of 37 or higher with a bud retention of 60% or higher. However, the higher embryo bud content rich in lipids makes the rice apt to undergo acidification. Further, there is greater possibility of heat resistant bacteria being present in rice containing embryo buds because of a greater content of the aleuron layer.

Such rice is commercially available for cooking at home. As for the aseptic preparation of instant rice, it has been applied only to germinated brown rice, and not yet to either partially brown rice nor to rice with embryo buds. This is not only because they are apt to acidify due to their high lipid contents in embryo buds, but because the aleuron layer remaining in the rice causes stickiness after immersion in water, which may lead to interrupting sterilization. In addition, the embryo buds are likely to fall off from the rice during such production processes as selecting, washing, immersing, transporting and the like.

Extensive research has been conducted into partially polished rice and rice with embryo buds. Korean Patent Unexamined Publication No. 10-2004-27850 discloses a preparation method of brown rice and embryo bud-retaining white rice products in which fully polished white rice, embryo buds and bran are separately packed. Korean Patent Unexamined Publication No. 10-1997-9592 discloses a method of the preparation of nutritional rice based on the embryo buds of rice and wheat and the bran (aleuron and testa) of rice, wheat and barley. That is, white rice, embryo buds and bran (aleuron, testa) are mixed together or are separately packed.

Rice-processed products based on partially polished rice or embryo bud-retaining white rice are also being studied. Korean Patent Unexamined Publication No. 10-2003-31058 describes a method and an apparatus for the preparation of rice-processed dough products using partially polished rice, chitosan and alkaline water. Korean Patent Unexamined Publication No. 10-2007-77510 discloses rice cakes with embryo buds and a method for preparing the same. Other various products based on rice embryo buds have been developed, including beverages, oils, food additives, wines, teas, soypaste mixed with red pepper, and soaps.

Korean Patent Unexamined Publication No. 10-2002-81577 discloses instant brown rice prepared by cooking just polished white rice together with bran and embryo buds, and a preparation method thereof. In the method of the patent, rice embryo buds and bran are separately added. Thus, the cooked rice looks messy and unappetizing because the embryo buds locally present thereon and the rice bran make the cooked rice yellowish. In addition, the cooked rice is impossible to store for more than one week because the rice embryo buds and bran are used without washing or sterilizing processes. When undergoing a washing process, rice embryo buds and bran are highly likely to coagulate and thus cannot be separately added. Further, white rice must be cooked in a mixture of rice embryo buds and bran due to lipid acidification. The addition process is further needed. The added rice embryo buds tend to stick to the carrying conveyor. These problems thus make it difficult to use this method in industrial applications.

Rice embryo bud-based rice products developed thus far are packages of white rice in separate association with rice bran and embryo buds, or packages of powdered partially polished rice.

As described above, embryo bud-retaining white rice is apt to undergo lipid oxidation during storage due to its high lipid content and apt to generate sticky materials after immersion due to the presence of the aleuron layer therein, increasing the possibility of incomplete sterilization. In addition, the embryo buds may readily fall off in the preparation processes including selecting, washing, immersing and transporting. Owing to these problems, embryo bud-retaining white rice is more difficult to prepare into an instant rice product than is white rice. Thus, nowhere is the study and development of an instant rice product based on embryo bud-retaining white rice mentioned in the prior art.

### DISCLOSURE

### Technical Problem

Leading to the present invention, intensive and thorough research into instant rice with richer nutrients, conducted by the present inventors, resulted in the finding that embryo bud-retaining white rice, which is polished using a low-speed, uniform-pressure method, can be prepared into an instant rice product which is rich in nutrients and has white rice's flavor by controlling a time period of immersion in water and the instant rice product can be stored at room temperature for 6 months or longer without significant changes in taste.

### Technical Solution

It is an object of the present invention to provide a method for preparing an instant embryo bud-retaining white rice product.

### Advantageous Effects

Based on the rice which is polished like white rice, but in such a low-speed, uniform pressure manner to keep embryo buds, the instant rice product according to the present invention is rich in nutrients with white rice's taste. Its lipid oxidation is similar to that of white rice. In addition, the immersion time period of the embryo bud-retaining white rice is controlled so as not to generate sticky materials after the immersion, thus allowing effective sterilization of the rice. As a result, the instant embryo bud-retaining white rice of the present invention can be stored at room temperature for 6 month or longer without the degeneration of taste.

### DESCRIPTION OF DRAWINGS

FIG. 1 is a process flow of preparing an instant embryo bud-retaining white rice in accordance with the present invention.

FIG. 2 is a graph showing changes in the water absorption rate of embryo bud-retaining white rice with time.

FIG. 3 is a view showing retention rates of embryo buds in the instant embryo bud-retaining white rice in accordance with the present invention.

FIG. 4 is a view showing peroxide values (POV) of the instant embryo bud-retaining white rice in accordance with the present invention.

### BEST MODE

The present invention provides a method for preparing instant embryo bud-retaining white rice, comprising:

(1) washing and immersing white rice with an embryo bud retention rate of from 40 to 70% in water;

(2) dewatering the rice and filling a heat-resistant plastic vessel with the dewatered rice;

(3) sterilizing the rice in the vessel at a high temperature and high pressure;

(4) cooking the rice with steam from UV-sterilized water; and

(5) applying nitrogen gas to the rice in a clean room, following by sealing the vessel with a lead film to completely cook the rice at a low temperature, cooling, drying and packaging the cooked rice in that order.

Below, a stepwise description is given of the method for preparing instant embryo bud-retaining white rice.

Step (1) is a pre-treatment step of embryo bud-retaining white rice. In this step, embryo bud-retaining rice is washed with pure water to remove starchiness and other impurities therefrom and is immersed at 10˜25° C. for 1˜2.5 hrs in pure water. When the rice is immersed for longer than 2.5 hrs, sticky materials are dissolved from the subaleuron layer of the rice and adhere to hoppers and conveyors during processing, causing trouble in processing. Also, they may disturb the sterilization of rice. On the other hand, an immersion time period less than 1 hr makes the rice half done, incurring a decrease in product quality.

In step (2), the pretreated embryo bud-retaining white rice is dewatered and placed in a heat-resistant plastic vessel.

In step (3), the vessel full of the embryo bud-retaining white bud is autoclaved four to ten times at 130˜150° C. for 4˜8 sec.

Step (4) is cooking the rice at 100° C. for 30˜35 min with steam from UV-sterilized cooking water.

Step (5) is producing instant embryo bud-retaining white rice products. In this regard, nitrogen gas is applied to the cooked rice in a cleanroom (class 100 or less, that is, a room containing 100 or less particles of a size of 0.5 μm or larger per cubic foot of air) to delay acidification, followed by sealing the vessel with a lead film to completely cook the rice, cooling, drying and packaging to afford an instant rice product.

The instant embryo bud-retaining white rice prepared according to the method of the present invention is richer in B vitamins, vitamin E, γ-oryzanol and linoleic acid than and is almost identical in whiteness (37˜40) and taste to general white rice.

During the aseptic preparation of instant embryo bud-retaining white rice in accordance with the present invention, a significant portion of the embryo buds fall off in the immersion step because the rice is thought to swell and weaken the bond of the embryo buds to the endosperm. Overall, the embryo buds fall off at a rate of from 5 to 10% as a result of the process. In order to ensure the presence of bud embryos at a retention rate of 30% or higher in the final instant rice product, therefore, the starting rice material must have embryo buds in an amount of 40% or higher based on the total number of rice grains and preferably in an amount of from 40 to 70% by number.

The packaged instant rice of the present invention increases in peroxide value with time during storage, but in a similar pattern to that of commercially available instant white rice products. This is thought to be attributed to the fact that, although rice embryo buds contain a significant amount of lipids, γ-oryzanol also present in the rice embryo buds serves as an antioxidant preventing lipid oxidation. Thus, almost no significant difference in lipid oxidation is found between the instant embryo bud-retaining white rice of the present invention and commercially available instant white rice products.

Consequently, the instant rice of the present invention is based on rice that keeps embryo buds even in the polishing process, and is rich in nutrients and has white rice's taste. Also, it shows lipid oxidation similar to that of white rice during storage. Since it is effectively sterilized due to the absence of stickiness resulting from controlling immersion time to a suitable period, the instant rice of the present invention can be stored for a time period of 6 months or longer.

### MODE FOR INVENTION

A better understanding of the present invention may be obtained through the following examples which are set forth to illustrate, but are not to be construed as limiting the present invention.

### Example 1

### Preparation of Instant Embryo Bud-Retaining White Rice

Embryo bud-retaining white rice was washed with pure water, immersed for 1.5 hrs in pure water, and dewatered. 110 Grams of the dewatered rice was placed in a heat-resistant vessel and sterilized at 140˜143° C. for 7 sec in an autoclayer (Shinwa). This autoclaving was repeated six more times. After the sterilization, the rice was cooked for 35 min with steam at 100° C. in a cooker with UV-sterilized water serving as cooking water. Thereafter, nitrogen gas was applied to the rice in a sterilized condition, sealed with a lead film, and allowed to stand for about 12 min to complete cooking, followed by cooling in water at 10° C. for 15 min to produce a packaged instant rice product.

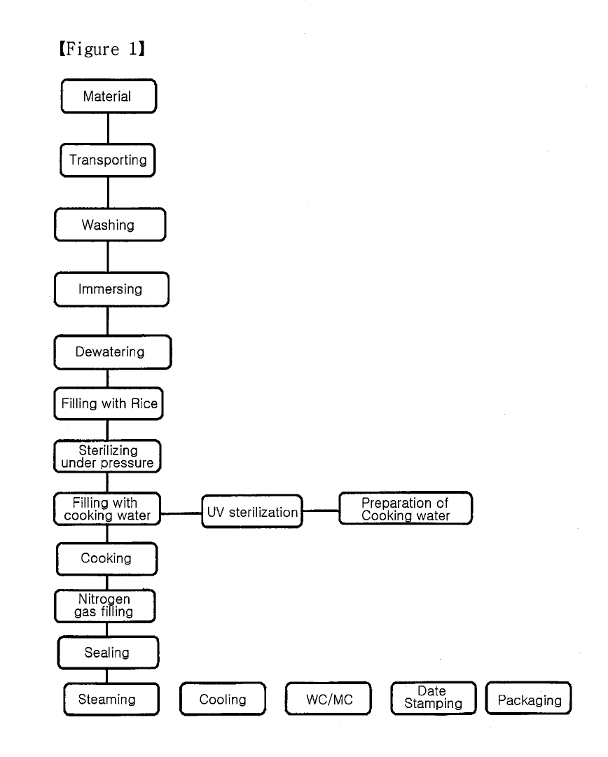

The process flow of preparing the instant embryo bud-retaining white rice in accordance with the present invention is shown in FIG. 1.

### Comparative Example 1

### Preparation of Instant White Rice

A packaged instant rice product was prepared in the same manner as in in Example 1 with the exception that white rice was used instead of embryo bud-retaining white rice.

### Experimental Example 1

### Determination of the Immersion Time Period of Embryo Bud-Retaining White Rice

After immersion in pure water, embryo bud-retaining white rice was measured for water absorption (weight after immersion/weight before immersion) as a function of immersion time (20, 40, 60, 80, 100 and 120 min) and compared to white rice in order to determine an optimal condition for immersion.

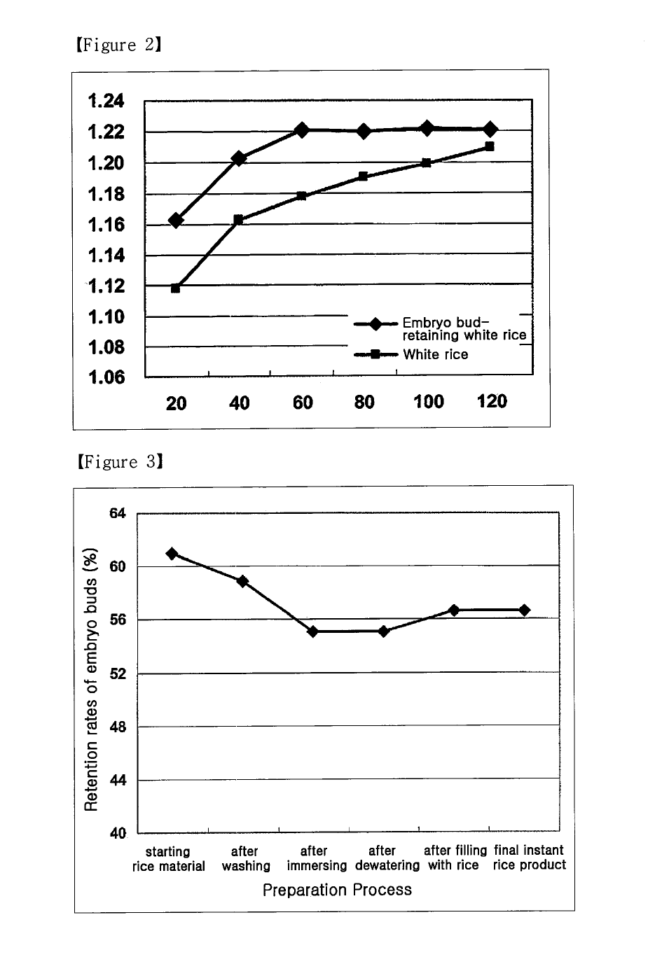

The results are given in Table 1 and FIG. 2.

TABLE 1

| | Time (min) | | | | | |
|---|---|---|---|---|---|---|
| | 20 | 40 | 60 | 80 | 100 | 120 |
| Embryo Bud-retaining White | 1.16 | 1.20 | 1.22 | 1.22 | 1.22 | 1.22 |
| Rice | | | | | | |
| White rice | 1.12 | 1.16 | 1.18 | 1.19 | 1.20 | 1.21 |

As seen in Table 1 and FIG. 2, the water absorption rate of embryo bud-retaining white rice increased with time to 60 min, after which no water absorption changes were detected. Embryo bud-retaining white rice still contains a sub-aleuron layer accounting for the sweet taste of rice. When immersed in water, the sub-aleuron layer holds water and this water is not removed even after the dewatering process of the rice, so that the embryo bud-retaining white rice may reach a maximum water absorption level. Hence, the optimum immersion time of embryo bud-retaining white rice was determined to range from 1 to 2.5 hrs. When the immersion time of embryo bud-retaining white rice exceeds 2.5 hrs, the sticky materials from the sub-aleuron layer may remain in the devices including hoppers, conveyors and the like during the preparation process, incurring troubles in processing and non-sterilization.

### Experimental Example 2

### Determination of the Optimal Sterilization Time for Embryo Bud-Retaining White Rice

When embryo bud-retaining white rice was immersed in water, it generated sticky materials in contrast to white rice. The sticky materials were tested for the influence on sterilization of the rice. In order to determine an optimal sterilization time, embryo bud-retaining white rice was compared to white rice using a MCT (Microbiology Challenge Test). MCT is an assay method for determining the safety of a product during preparation and transportation by inoculating test product aliquots with a known number of viable cells of several test organisms and assaying for survivors at various time intervals. After being immersed for 1 hr in water, embryo bud-retaining white rice and white rice were placed in respective vessels and inoculated with Bacillus spores at a density of 107 CFU/g at the cold point and sterilized for 6.5˜7.0 sec, followed by observation of the cell numbers.

Embryo bud-retaining white rice was observed to decrease in cell count at a rate of 0.85 log CFU/g upon sterilization for 6.5 sec and at a rate of 0.97 log CFU/g upon sterilization for 7.0 sec, which is the same level as white rice, 0.99 log CFU/g. However, when embryo bud-retaining white rice was immersed at 30° C. for 3 hrs or longer (generating the largest amounts of sticky materials), its cell reduction level was measured at 0.79 log CFU/g, indicating that the sticky materials decrease the sterilization effect. Thus, the effective sterilization time was determined to be 7.0 sec.

### Experimental Example 3

### Microbial Stability in Embryo Bud-Retaining White Rice and Determination of the Sterilization Condition

Embryo bud-retaining white rice with an embryo bud content of 50% or higher was measured for generic bacteria and heat-resistant bacteria levels and these were compared to those of white rice. Embryo bud-retaining white rice had heat-resistant cell at a density of 10 log CFU/g, which was not significantly different from that of white rice. As for generic bacteria, it was detected at a density of 5 log CFU/g in embryo bud-retaining white rice, which was larger than that of white rice by 0.5 log CFU/g. Therefore, the sterilization time for embryo bud-retaining white rice was set to a time period longer than that for white rice by 0.5 sec.

### Experimental Example 4

### Measurement of the Retention Rate of Embryo Bud in Instant Embryo Bud-Retaining White Rice

The instant embryo bud-retaining white rice product of the present invention was measured for embryo bud content by determining the falling rate of embryo buds over the overall preparation process. In this regard, a process in which the embryo buds fell off in the largest amount was inspected. Based on the results, the specification of the material rice was determined to ensure the quality of the final product (embryo bud content of 30% or higher).

The results are shown in FIG. 3.

As seen in FIG. 3, the embryo buds fall off at the greatest rate in the immersion step among the preparation processes because the rice swelled with water. The embryo buds fell off at a total rate of from 5 to 10% during the preparation process. Therefore, the starting rice material must retain embryo buds in an amount of 40% in order to ensure the presence of embryo buds at a rate of 30% or higher in the final instant rice product.

### Experimental Example 5

### Microbial Safety of Instant Embryo Bud-Retaining White Rice Product

A cell growth assay was conducted to investigate the safety from microbes of the instant embryo bud-retaining white rice product of the present invention. Generally, a cell growth assay is a microbe analysis method conducted for completely sterilized vessels or foods, such as canned provisions, retort foods, etc. In the present invention, 20 instant embryo bud-retaining white rice products prepared in Example 1 were subjected to cell growth assay to determine the growth of bacteria therein.

The results are given in Table 2, below.

TABLE 2

| Sample | Results |
|---|---|
| 1 | Negative |
| 2 | Negative |
| 3 | Negative |
| 4 | Negative |
| 5 | Negative |
| 6 | Negative |
| 7 | Negative |
| 8 | Negative |
| 9 | Negative |
| 10 | Negative |
| 11 | Negative |
| 12 | Negative |
| 13 | Negative |
| 14 | Negative |
| 15 | Negative |
| 16 | Negative |
| 17 | Negative |
| 18 | Negative |
| 19 | Negative |
| 20 | Negative |

As seen in Table 2, all the instant embryo bud-retaining white rice products prepared according to the method of the present invention were found to be safe from bacteria as measured by a cell growth assay. Based on this data, it can be inferred that the instant embryo bud-retaining white rice product of the present invention does not undergo denaturation for at least 6 months.

### Experimental Example 6

### Evaluation of Taste Quality of Instant Embryo Bud-Retaining White Rice

In order to evaluate taste qualities of the instant embryo bud-retaining white rice product of the present invention, a sensory test was conducted with 200 consumers 25˜45 years old. In the sensory test, the instant rice was evaluated for overall taste, chewing sensation, glutinosity, savoriness, sweetness and embryo bud appearance using a five-point scale (5: Very good, 4: Good, 3: Mediocre, 2: Poor, and 1: Very poor).

The results are given in Table 3, below.

TABLE 3

| Evaluation Items | Score (5-Point Scale) |
|---|---|
| Overall taste | 3.86 |
| Chewing sensation | 3.87 |
| Glutinosity | 3.88 |
| Savoriness | 3.99 |
| Sweetness | 3.91 |
| Embryo bud appearance | 4.32 |

As seen in Table 3, the instant embryo bud-retaining white rice product of the present invention gained high scores in all of the evaluation items, with excellence in savoriness, sweetness and embryo bud appearance categories. This was thought to be attributable to the presence of the sub-aleuron layer in embryo buds which accounts for the sweet taste of rice.

### Experimental Example 7

### Nutritional Analysis of Instant Embryo Bud Retaining Rice Product

The instant embryo bud-retaining rice product of the present invention was analyzed for nutrients, along with instant white rice. The results are given in Table 4, below.

TABLE 4

| | | Instant | Instant Embryo |
|---|---|---|---|
| | | White Rice | Bud-Retaining White |
| Nutrients | Unit | (C. Ex. 1) | Rice (Ex. 1) |
| Vitamin B1 | mg/100 g | 0.18 | 0.69 |
| Vitamin B2 | mg/100 g | 0.04 | 0.07 |
| Vitamin B6 | mg/100 g | 0.08 | 0.18 |
| Vitamin E | mg-α-TE/100 g | 0.03 | 0.29 |
| X-Orynazol | mg/100 g | 0.00 | 3.61 |
| Niacin | mgNE/100 g | 0.08 | 0.15 |
| Zinc | mg/100 g | 0.47 | 0.62 |
| Ca | mg/100 g | 6.78 | 9.24 |
| Linoleic Acid | % | 0.07 | 0.17 |

As seen in Table 4, the instant embryo bud-retaining white rice of the present invention was richer in all of the nutrients than instant white rice, and far richer particularly in the B vitamins, vitamin E, γ-orynazol and linoleic acid.

### Experimental Example 8

### Measurement of Degree of Lipid Oxidation of Instant Rice

The instant embryo bud retaining white rice of the present invention was analyzed for the degree of lipid oxidation as follows. While being stored at 25° C. for 6 months, the instant rice products prepared in Example 1 and Comparative Example 1 were measured for peroxide value (POV).

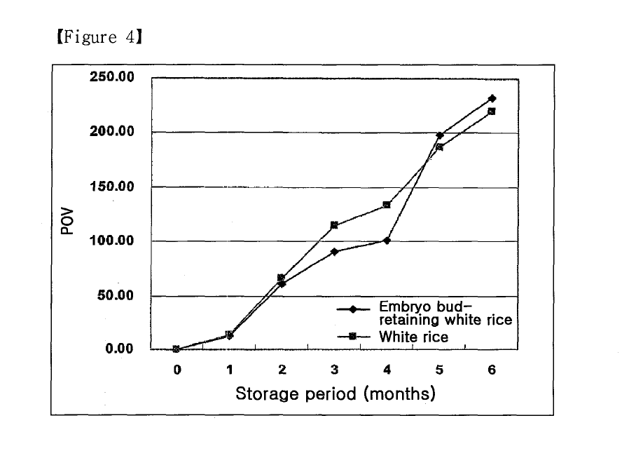

The results are given in FIG. 4.

As seen in FIG. 4, the instant embryo bud-retaining white rice product of the present invention increased in POV with time, but with no significant difference from the instant white rice product of Comparative Example 1. The lipids in the embryo buds, although abundant, were thought to be prevented from oxidization by the antioxidant γ-oryzanol also present in the embryo buds. Contrary to expectation, therefore, it was found that the embryo bud-retaining white rice did not differ in POV from white rice.

### Experimental Example 9

### Preservability of Instant Embryo Bud-Retaining White Rice

Since embryo bud-retaining white rice is inferior in preservability to white rice, the instant embryo bud-retaining white rice product of the present invention was monitored for quality during storage. The instant embryo bud-retaining white rice prepared in Example 1 was cooked for 2 min in a microwave oven and eaten by panels who had been long trained to evaluate for appearance (color), offensive taste and smell, glutinosity, texture and overall taste according to a 5-point scale (5: Very good, 4: Good, 3: Mediocre, 2: Poor, and 1: Very poor).

The results are given in Table 5, below.

TABLE 5

| Storage | | Offensive | | | |
|---|---|---|---|---|---|
| Period | Appearance | Taste and | Glutinosity | Texture | Overall |
| (Month) | (Color) | Smell | Preference | Preference | Taste |
| 0 | 3.51 | 0.00 | 3.68 | 3.66 | 3.95 |
| 1 | 3.53 | 0.12 | 3.55 | 3.81 | 3.82 |
| 2 | 3.44 | 0.66 | 3.46 | 3.60 | 3.81 |
| 3 | 3.45 | 0.81 | 3.94 | 4.06 | 3.83 |
| 4 | 3.41 | 1.51 | 3.63 | 3.62 | 3.73 |
| 5 | 3.43 | 1.58 | 3.60 | 3.53 | 3.68 |
| 6 | 3.31 | 1.62 | 3.90 | 3.79 | 3.66 |

As seen in Table 5, the instant embryo bud-retaining white rice of the present invention showed almost no changes in glutinosity and texture, but slightly decreased in overall taste. This is thought to be attributed to the fact that with time it turned darker and increased in offensive taste and smell degree. However, the evaluation values exceeded 3 which is a hurdle standard for any product. Thanks to the presence of the sub-aleuron layer responsible for the sweet taste of rice, the instant embryo bud-retaining white rice of the present invention could retain overall taste quality during storage.

### INDUSTRIAL APPLICABILITY

Based on the rice which is polished like white rice, but in such a low-speed, uniform pressure manner as to retain embryo buds, the instant rice product according to the present invention is rich in nutrients with white rice's taste. Its lipid oxidation is similar to that of white rice. In accordance with the present invention, the immersion time period of the embryo bud-retaining white rice is controlled so as not to generate sticky materials after immersion, thus allowing effective sterilization of the rice. As a result, the instant embryo bud-retaining white rice of the present invention can be stored at room temperature for 6 months or longer.

1. A method for preparing embryo bud-retaining white rice, comprising:
(1) washing and immersing white rice with an embryo bud retention rate of from 40 to 70% in water;
(2) dewatering the rice and filling a heat-resistant plastic vessel with the dewatered rice;
(3) sterilizing the rice in the vessel at a high temperature and a high pressure;
(4) cooking the rice with steam from UV-sterilized water; and
(5) applying nitrogen gas to the rice in a clean room, following by sealing the vessel with a lead film to completely cook the rice at a low temperature, cooling, drying and packaging the cooked rice in that order.

2. The method according to claim 1, wherein the immersing is conducted at 10˜25° C. for 1˜2.5 hrs in pure water.

3. The method according to claim 1, wherein the sterilizing is conducted four to ten times at 130˜150° C. for 4˜8 sec.

4. The method according to claim 1, wherein the cooking is conducted with steam at 100° C. for 30˜35 min.

5. The method according to claim 1, wherein the embryo bud-retaining white rice ranges in whiteness from 37 to 40.
